(19) United States
(12) Patent Application Publication
(10) Pub. No.: US 2025/0373513 A1
(43) Pub. Date: Dec. 4, 2025

(54) MANAGING HORIZONTAL FEDERATED LEARNING SERVICE

(71) Applicant: Lenovo (United States) Inc., Morrisville, NC (US)

(72) Inventor: Roozbeh ATARIUS, La Jolla, CA (US)

(21) Appl. No.: 19/300,323

(22) Filed: Aug. 14, 2025

(51) Int. Cl. H04L 41/16; H04L 67/02; H04W 8/20

(52) U.S. Cl. CPC H04L 41/16; H04L 67/02; H04W 8/20

(57) ABSTRACT

Various aspects of the present disclosure relate to a User Equipment (UE) configured to or operable to receive, from a network entity, a request associated with a Horizontal Federated Learning (HFL) subscription for retrieving information associated with the HFL subscription, for modifying information associated with the HFL subscription, or for terminating the HFL subscription, and transmit, to the network entity, a response associated with the HFL subscription based at least in part on the received request, wherein the UE is an Artificial Intelligence Machine Learning Enablement (AIMLE) client, and wherein the network entity is an AIMLE server.

### TECHNICAL FIELD

The present disclosure relates to wireless communications, and more specifically to communications associated with a Horizontal Federated Learning (HFL) training service.

### BACKGROUND

A wireless communications system may include one or multiple network communication devices, otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., 5G-Advanced (5G-A), sixth generation (6G), etc.).

### SUMMARY

As used herein, including in the claims, an article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Further, as used herein, including in the claims, a “set” may include one or more elements.

The devices (e.g., NE, UE), processors, and methods of the present disclosure each have several innovative aspects, no single one of which is solely responsible for the desirable features disclosed herein.

A UE for wireless communication is described. The UE may be configured to, capable of, or operable to receive, from a network entity, a request associated with a HFL subscription for retrieving information associated with the HFL subscription, for modifying information associated with the HFL subscription, or for terminating the HFL subscription, and transmit, to the network entity, a response associated with the HFL subscription based at least in part on the received request, wherein the UE is an Artificial Intelligence Machine Learning Enablement (AIMLE) client, and wherein the network entity is an AIMLE server.

A processor (e.g., a standalone processor chipset, or a component of a UE) for wireless communication is described. The processor may be configured to, capable of, or operable to perform one or more operations as described herein. For example, the processor may be configured to, capable of, or operable to receive, from a network entity, a request associated with a HFL subscription for retrieving information associated with the HFL subscription, for modifying information associated with the HFL subscription, or for terminating the HFL subscription, and transmit, to the network entity, a response associated with the HFL subscription based at least in part on the received request, wherein the UE is an AIMLE client, and wherein the network entity is an AIMLE server.

A method performed or performable by a UE for wireless communication is described. The method may include receiving, from a network entity, a request associated with a HFL subscription for retrieving information associated with the HFL subscription, for modifying information associated with the HFL subscription, or for terminating the HFL subscription, and transmitting, to the network entity, a response associated with the HFL subscription based at least in part on the received request, wherein the UE is an AIMLE client, and wherein the network entity is an AIMLE server.

In some implementations of the UE and method described herein, transmitting the response associated with the HFL subscription includes outputting training subscription data based at least in part on the received request being for retrieving information associated with the HFL subscription.

In some implementations of the UE and method described herein, the request is a Hypertext Transfer Protocol (HTTP) GET request.

In some implementations of the UE and method described herein, the response comprises the training subscription data requested by the network entity.

Some implementations of the UE and method described herein include modifying one or more parameters associated with the HFL subscription based at least in part on the received request being for modifying information associated with the HFL subscription.

In some implementations of the UE and method described herein, the request is an HTTP PATCH request, and wherein the HTTP PATCH request indicates at least one parameter to be modified and a modified value for the at least one parameter.

Some implementations of the UE and method described herein include replacing the HFL training service, to which the network is subscribed with the UE, wherein the request is an HTTP PUT request.

Some implementations of the UE and method described herein include terminating an HFL subscription of the UE based at least in part on the received request being terminating the HFL subscription.

In some implementations of the UE and method described herein, the request is an HTTP DELETE request.

An NE (e.g., an AIMLE server or base station) for wireless communication is described. The NE may be configured to, capable of, or operable to perform one or more operations as described herein. For example, the NE may be configured to, capable of, or operable to transmit, to a UE, a request associated with a HFL subscription for retrieving information associated with the HFL subscription, for modifying information associated with the HFL subscription, or for terminating the HFL subscription, and receive, from the UE, a response associated with the HFL subscription based at least in part on the received request, wherein the UE is an AIMLE client, and wherein the network entity is an AIMLE server.

A processor (e.g., a standalone processor chipset, or a component of a NE) for wireless communication is described. The processor may be configured to, capable of, or operable to perform one or more operations as described herein. For example, the processor may be configured to, capable of, or operable to transmit, to a UE, a request associated with a HFL subscription for retrieving information associated with the HFL subscription, for modifying information associated with the HFL subscription, or for terminating the HFL subscription, and receive, from the UE, a response associated with the HFL subscription based at least in part on the received request, wherein the UE is an AIMLE client, and wherein the network entity is an AIMLE server.

A method performed or performable by a NE for wireless communication is described. The method may include transmitting, to a UE, a request associated with a HFL subscription for retrieving information associated with the HFL subscription, for modifying information associated with the HFL subscription, or for terminating the HFL subscription, and receiving, from the UE, a response associated with the HFL subscription based at least in part on the received request, wherein the UE is an AIMLE client, and wherein the network entity is an AIMLE server.

### BRIEF DESCRIPTION OF THE DRAWINGS

FIG. 1 illustrates an example of a wireless communications system in accordance with aspects of the present disclosure.

FIG. 2 illustrates an example of a signaling diagram in accordance with aspects of the present disclosure.

FIG. 3 illustrates an example of a resource Uniform Resource Identifier (URI) structure for an Application Programming Interface (API) in accordance with aspects of the present disclosure.

FIG. 4 illustrates an example of a UE in accordance with aspects of the present disclosure.

FIG. 5 illustrates an example of a processor in accordance with aspects of the present disclosure.

FIG. 6 illustrates an example of a NE in accordance with aspects of the present disclosure.

FIG. 7 illustrates a flowchart of method performed by a UE in accordance with aspects of the present disclosure.

FIG. 8 illustrates a flowchart of method performed by a NE in accordance

with aspects of the present disclosure.

### DETAILED DESCRIPTION

Horizontal Federated Learning (HFL) is a collaborative machine learning approach where multiple parties train a model on their local datasets without sharing the raw data. In a HFL training service, an Artificial Intelligence Machine Learning Enablement (AIMLE) server subscribes to an HFL training event with AIMLE clients to obtain the machine learning (ML) model parameters for a one or more Vertical Application Layer (VAL) service. HFL training is an iterative process and is performed over numerous training rounds with multiple AIMLE clients.

The HFL training service may be performed by an AIMLE server that receives an ML model training request from a VAL server. The AIMLE server may retrieve a requested ML model and obtain the ML model parameters for the VAL service by selecting several of the AIMLE clients and configuring training schedules for each of these AIMLE clients. The AIMLE server may then provide this information to the VAL server. However, current HFL capabilities limit the AIMLE server to subscribing to AIMLE clients associated with an HFL training event.

The present disclosure introduces additional functionalities for an HFL training service, including the ability to modify or retrieve information related to an HFL training service and to terminate an HFL subscription. These new functionalities enhance the training process by enabling the AIMLE server to have greater control over the training process.

Aspects of the present disclosure are described in the context of a wireless communications system.

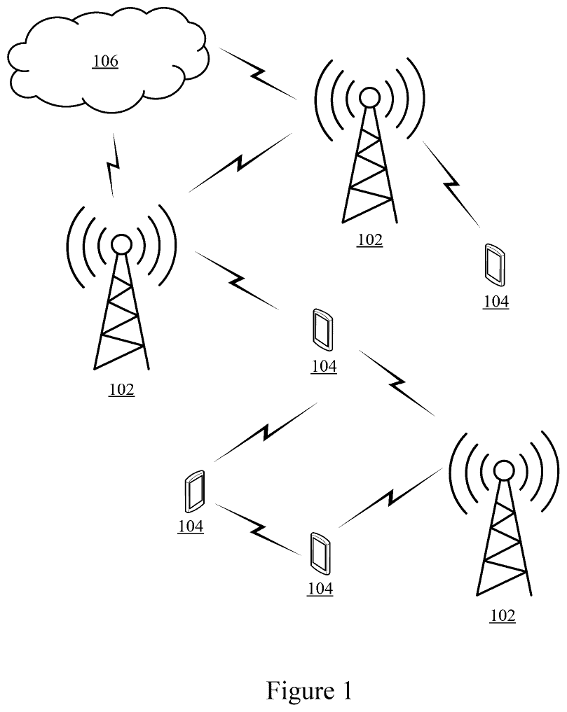

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas 112 associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 114 may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N2, or network interface). In some implementations, the NE 102 may communicate with each other directly. In some other implementations, the NE 102 may communicate with each other or indirectly (e.g., via the CN 106. In some implementations, one or more NE 102 may include subcomponents, such as an access network entity, which may be an example of an access node controller (ANC). An ANC may communicate with the one or more UEs 104 through one or more other access network transmission entities, which may be referred to as radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N2, or another network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHZ-24.25 GHz), FR4 (52.6 GHz-114.25 GHz), FR4a or FR4-1 (52.6 GHz-71 GHz), and FR5 (114.25 GHZ-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

The entities shown in FIG. 1 may perform aspects of the present disclosure. For example, one or more of the UEs 104 in FIG. 1 may receive, from a NE 102, a request associated with a Horizontal Federated Learning (HFL) subscription for retrieving information associated with the HFL subscription, for modifying information associated with the HFL subscription, or for terminating information associated with the HFL subscription, and transmit, to the NE 102, a response associated with the HFL subscription based at least in part on the received request. The NEs 102 may cooperate with CN 106 to perform ML model retrieval and client selection.

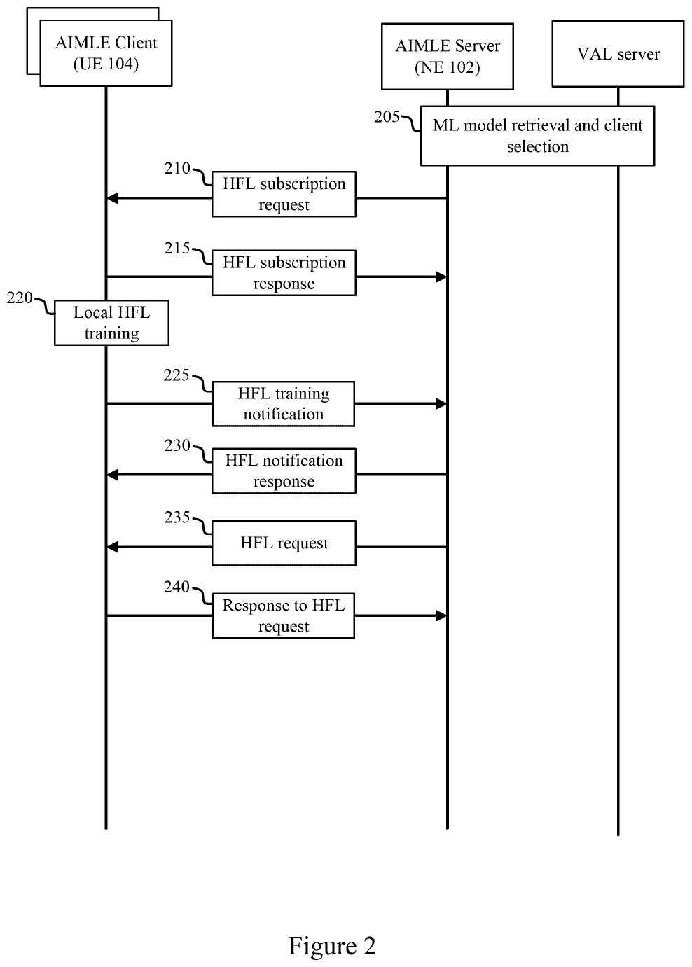

FIG. 2 illustrates an example of a signaling diagram in accordance with aspects of the present disclosure. In some examples, the signaling diagram implements or is implemented by aspects of the wireless communications system 100. The signaling diagram may implement or be implemented by one or more devices, such as an NE 102 and a UE 104, which may be examples of an NE 102 and a UE 104 as described with reference to FIG. 1. The signaling diagram may illustrate an example of an AIMLE-related procedure between the NE 102 and the UE 104. Alternative examples of the following may be implemented, where some processes are performed in a different order than described or are not performed. In some cases, processes may include additional features not mentioned below, or further processes may be added.

Each of one or more of the NE 102 and the UE 104 may be configured with a protocol stack including various functional layers. For example, the protocol stack may include, but is not limited to, a physical (PHY) layer configured to perform modulation, coding, and transmission of data over a physical radio channel; a medium access control (MAC) layer configured to perform scheduling, multiplexing, and error correction; a radio link control (RLC) layer configured to provide segmentation, reassembly, and retransmission of data; and a packet data convergence protocol (PDCP) layer configured to perform header compression, ciphering, and integrity protection. In some examples, higher-layer protocols may include a radio resource control (RRC) layer configured to manage radio bearers and mobility, and a non-access stratum (NAS) layer configured to handle core network signaling, session management, and mobility management. Above these layers, an application (APP) layer may be present, which can execute end-user or network applications and may interface with service and application frameworks. The APP layer may carry, for example, services, AI/ML-enabled network analytics, vertical-industry applications, etc.

In the example of FIG. 2, the NE 102 may be implemented as an AIMLE server or as a base station (e.g., gNB) in communication with the AIMLE server. In some examples, the NE 102 may be a server coupled with (e.g., operatively, communicatively, functionally, electronically, electrically) a Vertical Application Layer (VAL) server, which may be an element of or coupled with a CN 106.

HFL training service operations may include Machine Learning (ML) model retrieval and client selection 205. For example, an AIMLE server (NE 102) may receive an ML model training request from a VAL server. If the NE 102 agrees to the HFL training request, the NE 102 may retrieve one or more ML model indicated by the request from the VAL server and perform AIMLE client selection using AIMLE client selection criteria or a list of AIMLE clients provided by the VAL server, for example.

If AIMLE client selection criteria are available, then the NE 102 may continuously monitor and select AIMLE clients (e.g., UEs 104) for the HFL training. If a set of AIMLE clients is provided to the NE 102 (e.g., from the VAL server), the NE 102 may select AIMLE clients for HFL training from the provided set. The NE 102 may check with the selected AIMLE clients for their capability and willingness to participate in the HFL training to determine an AIMLE client set.

After an AIMLE client set is determined, the NE 102 configures a training schedule for each AIMLE client (e.g., UE 104) and transmits a HFL training subscription request 210 with relevant information to UEs 104. Each UE 104 that receives the HFL training subscription request 210 transmits a HFL training subscription response 215 which may indicate the willingness of the UE 104 to participate in the training. If a UE 104 is not able to grant the subscription (e.g., is not able to perform the training), the UE 104 may transmit a response indicating a failure status to the NE 102.

Subsequently, each UE 104 that is subscribed to the HFL training service performs local training at 220 using a configured AI/ML model, model parameters, and prepared local data associated with a dataset identifier for a specified number of samples according to the operational schedule of the HFL training service.

After completing local training tasks or when errors are encountered when collecting samples for training, each UE 104 may transmit an HFL training notification 225 to the AIMLE server. The UE 104 may provide a VAL service identifier (ID) and other information for the associated HFL training operation in the training notification 225, and the NE 102 may transmit a response 230 (e.g., HFL notification response as indicated in FIG. 2) to the training notification 225.

In implementations of the present disclosure, after subscriptions are established, the NE 102 may transmit an HFL request 235 to one or more UE 104 that is subscribed to the HFL training service. The request 235 may be transmitted at any time after an HFL training subscription is established, including before any training notifications 225 are transmitted by the one or more UE 104.

The request 235 may be a request associated with a HFL subscription for retrieving information associated with the HFL subscription, for modifying information associated with the HFL subscription, or for terminating the HFL subscription. Each of these types of HFL request 235 will be discussed in more detail below.

An application programming interface (API) may be available for operations related to subscription, retrieval, modification, termination and notifications associated with an HFL training service. The API may be referred to herein as an Aimlec_HFLTraining API. In some other examples, the API and associated service operations may be identified by different names while providing similar or the same functionality

Service operations which may be supported by the Aimlec_HFLTraining API include an HFL training subscription. An HFL training subscription service operation allows a service consumer, e.g., the AIMLE server (NE 102), to create an HFL training subscription. This service operation may be used by the service consumer (NE 102) to subscribe with each AIMLE client (UE 104) for HFL training event.

To subscribe to the HFL training event with the UE 104, the NE 102 may transmit an HFL subscription request 210 with an HTTP POST format containing an HFL training subscription structured data type, which is referred to as a HFLTrngSub structure data type in the present disclosure.

The HFLTrngSub structure data type may have one or more of the following features:

A Universal Resource Identifier (URI) data type (e.g., notifURI) which identifies an URI towards which a message should be delivered;
An AIML model information field (e.g., aimlMdlInfo) which identifies information about the AIML model and the model parameters which are to be used for HFL training;
A data ID string (e.g., dataID) which identifies the dataset which is to be used for the HFL training;
An integer value (e.g., noDataSamp) which identifies a number of samples to be used for a round of HFL training;
Schedule information (e.g., operSched) which identifies a schedule (e.g., specific times or time intervals) for HFL training operations;
Reporting requirements (e.g., notifReqs) which identify requirements for reporting HFL training data from the UE 104 to the NE 102, which may include one or more of the reporting requirements of 3GPP TS 29.549 “Service Enabler Architecture Layer for Verticals (SEAL); Application Programming Interface (API) specification; Stage 3” V19.3.0 (2025-06), incorporated herein by reference in its entirety;
Supported feature information (e.g., suppFeat), which may be used to negotiate the applicability of optional features. This attribute may be present when feature negotiation takes place, and may be present in both an HTTP request and response. Feature negotiation may be performed according to clause 5.2.7 of 3GPP TS 29.122 “T8 reference point for Northbound APIs”, V19.3.0 (2025-06), incorporated herein by reference in its entirety;
An identifier of a VAL service (e.g., vaSrvId) which identifies the VAL service for an AIMLE HFL training operation; and
A subscription identifier (e.g., subID) which identifies the HFL associated subscription.

After receiving the HFL subscription request 210 from the NE 102, the UE 104 may verify the identity of the NE 102 and determine if the NE 102 is authorized for the request. If the NE 102 is not authorized to subscribe to the HFL training event, the UE 104 may respond to the NE 102 with an error cause (e.g., error code). Otherwise, if the NE 102 is authorized to subscribe to the HFL training event, the UE 104 may create the HFL training event subscription and store the subscription information.

If the UE 104 has created the subscription, the UE 104 may include an indication of success, an HTTP “Location” header containing the URI of the newly created resource, and the HFLTrngSub structure data type in the response 215.

If the UE 104 has not created the subscription, in the response, the UE 104 may include an indication of failure that the subscription is not created and include an error cause (e.g., error code) in the response 215.

Another operation which may be supported by the API is a retrieval operation, which may allow the NE 102 to retrieve information associated with an existing individual HFL training subscription. A retrieval service operation may be used by a service consumer, e.g., the NE 102, to retrieve information associated with an existing individual HFL training event subscription from the UE 104. In some implementations, the HFL request 235 is an HFL retrieval request.

To retrieve an individual HFL training event subscription with the UE 104, the NE 102 transmits the HFL request 235 (e.g., retrieval request), which may be an HTTP GET request, to the UE 104.

The HFL request 235 may be associated with an established subscription which was requested by the NE 102 for at least one HFL training event with the one or more UEs 104 which have created the associated individual resource for the subscription. Therefore, there may be one or more individual resources which are associated to the one or more UEs. In some implementations, an HTTP GET request may be used by the NE 102 to retrieve information associated with an individual resource of one or more UE 104 for the subscription.

Upon receipt of a HTTP GET request from the NE 102, the UE 104 may verify the identity of the NE 102 and determine if the NE 102 is authorized for the request. If the NE 102 is not authorized to retrieve the existing individual HFL training event subscription, the UE 104 may respond to the NE 102 with an error cause (e.g., error code). If the NE 102 is authorized to retrieve the existing individual HFL training event subscription information and if the receival request is handled locally, the UE 104 may retrieve the existing individual HFL training subscription information and provide that information to the NE 102 in a response 240.

If the UE 104 has retrieved the subscription information, the UE 104 may include an indication of success in the response 240. The response 240 may include any of the information of the HFLTrngSub structure data type discussed above, for example, which may be referred to as training subscription data. The response 240 may include any information requested by the NE 102 in the GET request.

If the UE 104 has not retrieved the subscription information, the UE 104 may include an indication of failure in the response 240 and may include error cause (e.g., error code) associated with the failure. In some implementations, the UE 104 may respond with an HTTP “307 Temporary Redirect” status code or an HTTP “308 Permanent Redirect” status code including an HTTP “Location” header containing an alternative URI representing the end point of an alternative UE 104 towards which a different request 235 is to be sent. Aspects of redirection handling may be implemented as described in clause 5.2.10 of 3GPP TS 29.122 V19.3.0.

Another operation which may be supported by the API is a modification operation, which may allow the NE 102 to modify/update an existing individual HFL training subscription. A modification operation may be used by the NE 102 to modify an existing individual HFL training event subscription with the UE 104. The modification may be a change to one or more HFL training parameter, such as a schedule, number of samples, type of measurement, reporting criteria, notification requirements which identify when the UE 104 is to transmit a notification (e.g., based on a time period, a completion of a task, etc.), a dataset, an AIML model, etc. In some implementations, the modification is a full replacement of HFL training parameters at the UE 104.

To modify an existing individual HFL training event subscription with the UE 104, the NE 102 may transmit a request 235 that is an HTTP PATCH request to the UE 104. The HTTP PATCH request may be transmitted to modify a portion of the HFL training parameters that are being used by the UE 104. The HTTP PATCH request for a partial update may contain an HFL training subscription patch structure data type, which is referred to as a HFLTrngSubPatch structure data type in the present disclosure.

The HFLTrngSubPatch structure data type may have one or more of the following features:
A Universal Resource Identifier (URI) data type (e.g., notifURI) which identifies an URI towards which the notification should be delivered;
An AIML model information field (e.g., aimlMdlInfo) which identifies information about the AIML model and the model parameters which are to be used for HFL training;
A data ID string (e.g., dataID) which identifies the dataset which is to be used for the HFL training;
An integer value (e.g., noDataSamp) which identifies a number of samples to be used for a round of HFL training;
Schedule information (e.g., operSched) which identifies a schedule (e.g., specific times or time intervals) for HFL training operations;
Reporting requirements (e.g., notifReqs) which identify requirements for reporting HFL training data from the UE 104 to the NE 102.

In another implementation, the modification requested by the request 235 is a request for full replacement of HFL training parameters. In this implementation, the request 235 may be an HTTP PUT request containing the HFLTrngSub structure data type as described above.

Upon receipt of the HTTP PATCH request 235 or HTTP PUT request 235 from the NE 102, the UE 104 may verify the identity of the NE 102 and determine if the NE 102 is authorized for the request. If the NE 102 is not authorized to modify the existing individual HFL training event subscription, the UE 104 may respond to the NE 102 with an error cause (e.g., error code).

If the NE 102 is authorized to modify the existing individual HFL training event subscription and if the received request is handled locally, the UE 104 may update the existing individual HFL training event subscription based on the subscription information indicated in the request 235.

If the UE 104 has modified the subscription in accordance with a request 235 that is a modification request, the UE 104 may include an indication of success and may include the HFLTrngSub structure data type in the response 240 to the request 235. If the UE 104 has not modified the subscription, the UE 104 may include an indication of failure and may include an error cause (e.g., error code) in the response 240.

Alternatively, if the request 235 is redirected, the UE 104 may respond with an HTTP “307 Temporary Redirect” status code or an HTTP “308 Permanent Redirect” status code including an HTTP “Location” header containing an alternative URI representing the end point of an alternative UE 104 towards which a different request 235 may be transmitted in a response 240.

Another operation which may be supported by the API is a terminate or unsubscribe operation, which may allow the NE 102 to terminate or delete an existing individual HFL training subscription. This service operation may be used by a service consumer e.g., the NE 102, to unsubscribe an existing individual HFL training event subscription with the UE 104 by transmitting an HFL request 235 for terminating an HFL subscription. In this implementation, the HFL request 235 may be an HTTP DELETE request.

Upon receipt of an HTTP DELETE request 235 from an NE 102, the UE 104 may verify the identity of the NE 102 and determine if the NE 102 is authorized for the request. If the NE 102 is not authorized to unsubscribe for the existing individual HFL training event subscription, the UE 104 may respond to the NE 102 with an error cause (e.g., error code).

If the NE 102 is authorized to update the existing individual HFL training event subscription and if the received request is handled locally, the UE 104 may unsubscribe the existing individual HFL training event subscription.

The UE 104 may transmit a response 240 to the request 235 to terminate the HFL subscription. If the UE 104 has unsubscribed the subscription, the response 240 may include an indication of success. If the UE 104 has not unsubscribed the subscription, the response 240 may include an indication of failure and may include an error cause (e.g., error code).

Alternatively, if the request 235 is redirected, the UE 104 may respond with an HTTP “307 Temporary Redirect” status code or an HTTP “308 Permanent Redirect” status code including an HTTP “Location” header containing an alternative URI representing the end point of an alternative UE 104 towards which the request may be sent in a response 240.

Another operation which may be supported by the API is a notify operation, which may be initiated by a UE 104 and allow the NE 102 to receive HFL training notifications. This service operation may be used by the UE 104 to notify a service consumer e.g., the NE 102, with information about the HFL training event.

The notify operation may be associated with transmitting the HFL training notification 225. The notification 225 may be transmitted periodically when a round of training is completed, when training is complete, and possibly at other times during training. Accordingly, in some implementations, notifications 225 may be transmitted before and/or after the HFL request 235 and response 240 are exchanged.

To notify about the HFL training event to the NE 102, the UE 104 may transmit to the NE 102 an HTTP POST request containing an HFLTrngNotify data structure. The HFLTrngNotify data structure may have one or more of the following features:

A VAL service identifier (e.g., vaSrvId) which identifies a VAL service for the AIMLE HFL training operation which is associated with the notification 225;
ML model parameters from the HFL training;
One or more training error, or a list of errors, encountered in conjunction with the HFL training operation associated with the notification 225; and
A time stamp (e.g., DateTime) which identifies a time of the notification 225.

Upon receipt of the notification 225 from the UE 104, the NE 102 may verify the identity of the UE 104 and determine if the UE 104 is authorized for the request. If the UE 104 is not authorized, the NE 102 may respond to the UE 104 with an error cause (e.g., error code). If the UE 104 is authorized to notify for the HFL training subscription and if the received request is handled locally, the NE 102 may respond by transmitting an HFL notification response 230 to the UE 104 with an HTTP “204 No Content” status code if the HTTP POST request is handled successfully.

If the HTTP POST request is not handled successfully, the NE 102 may respond by transmitting an HFL notification response 230 to the UE 104 with an error cause (e.g., error code). Otherwise, the UE 104 may respond with an HTTP “307 Temporary Redirect” status code or an HTTP “308 Permanent Redirect” status code including an HTTP “Location” header containing an alternative URI representing the end point of an alternative UE 104 towards which the request may be sent in a notification response 230.

The Aimlec_HFLTraining API may include a URI with the following structure: {apiRoot}/<apiName>/<apiVersion>. The URIs for the HFL request 235 may have the following structure: {apiRoot}/<apiName>/<apiVersion>/<apiSpecificSuffixes>. The {apiRoot} may be set as described in clause 5.2.4 of 3GPP TS 29.122 V19.3.0. The <apiName>may be “aimlec-hfl-trng”, for example. In some implementations, the <apiVersion>may be “v1”, or another version.

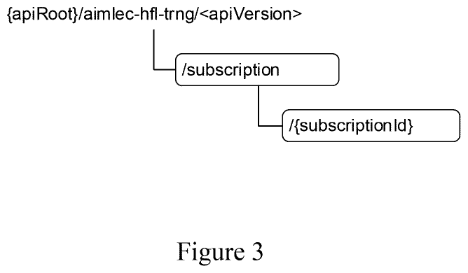

FIG. 3 illustrates an example of a resource URI structure for the Aimlec_HFLTraining API in accordance with aspects of the present disclosure. The URI structure shown in FIG. 3 may be implemented for HTTP GET, PUT, PATCH and DELETE operations.

As discussed above, for an individual HFL training subscription, an HTTP GET operation may be used to retrieve an existing Individual HFL training subscription resource, an HTTP PUT operation may be used to request the full replacement of an existing Individual HFL training subscription resource, an HTTP PATCH operation may be used to request the partial replacement of an existing Individual HFL training subscription resource, and an HTTP DELETE operation may be used to request the deletion of an existing Individual HFL training subscription resource. Each of these operations, which are associated with an HFL request 235 and response 240, may be made with respect to an individual HFL training subscription designated as/subscription/{subscriptionId} in FIG. 3. The HFL subscription request 210 may be an HTTP POST operation for an HFL training subscription designated as/subscription.

In some implementations, the AIMLE server subscription request 210 includes the URI structure {apiRoot}/aimlec-hfl-trng/<apiVersion>/subscription, and may include the HFLTrngSub data structure.

Similarly, a POST response body of the HFL subscription response 215 may have the HFLTrngSub data structure, and may comprise a 201 created response code, which indicates a successful subscription. This code is confirmation of the creation of an individual HFL training subscription resource, and a representation of that resource is returned. An HTTP “Location” header that contains the URI of the created resource may also be included in the response 215. In the case of an error, the response 215 may include a 4XX client error code. The Location header may include a data string with the URI of the newly created resource, according to the structure: {apiRoot}/aimlec-hfl-trng/<apiVersion>/subscription {subscriptionId}.

The same URI, {apiRoot} /aimles-hfl-trng/<apiVersion>/subscription/{subscriptionId}, also indicated in FIG. 3, may be associated with an individual HFL training subscription. For this URI, the subscriptionId may represent the identifier of an individual HFL training subscription resource.

A response 240 to a retrieval request 235 may be an HTTP GET message which may include a 200 OK response code which indicates that the requested Individual HFL training subscription resource is successfully retrieved, and a representation of the updated resource may be returned in the response body. For redirection, the response 240 may include a 307 temporary redirect code or a 308 permanent redirect code, and a Location header field containing an alternative URI of the resource located in an alternative AIMLE client. In the case of an error, the HTTP GET response 230 may include a 4XX client error code.

A response 240 to a terminate request 235 may be an HTTP DELETE message including a 204 no content response code which indicates that the individual HFL training subscription resource was successfully deleted. The HTTP DELETE message may include the same 307, 308 and 4XX codes described above.

A response 240 to a modification request 235 for full replacement of an HFL training subscription resource may be an HTTP PUT message which may include a 200 OK response code which indicates that the resource is successfully updated, and a representation of the updated resource may be returned in the response body. Alternatively, the response 240 may include a 200 no content response code which indicates that the Individual HFL training subscription resource is successfully updated, and no content is returned in the response body. The HTTP PUT message may include the same 307, 308 and 4XX codes described above.

A response 240 to a modification request 235 for partial replacement of an HFL training subscription resource may be an HTTP PATCH message which may include a 200 OK response code which indicates that the Individual HFL training subscription resource is successfully modified. and a representation of the updated resource may be returned in the response body. Alternatively, the response 240 may include a 204 no content response code which indicates that the Individual HFL training subscription resource is successfully modified, and no content may be returned in the response body. The HTTP PUT message may include the same 307, 308 and 4XX codes described above.

Each of the HTTP GET, DELETE, PUT and PATCH responses 240 may include the HFLTrngSub data structure discussed above, including one or more of the information fields associated with that data structure.

If training was successful, the NE 102 aggregates (e.g. averages) the model parameters received from the UEs 104 that participated in the training. When the training schedule has been exhausted (e.g. there are no remaining training rounds) and if so configured, the AIMLE server (e.g., NE 102) may create a ML model information storage request to store the AI/ML model in the ML repository. The NE 102 may then send a ML model training notification to the VAL server.

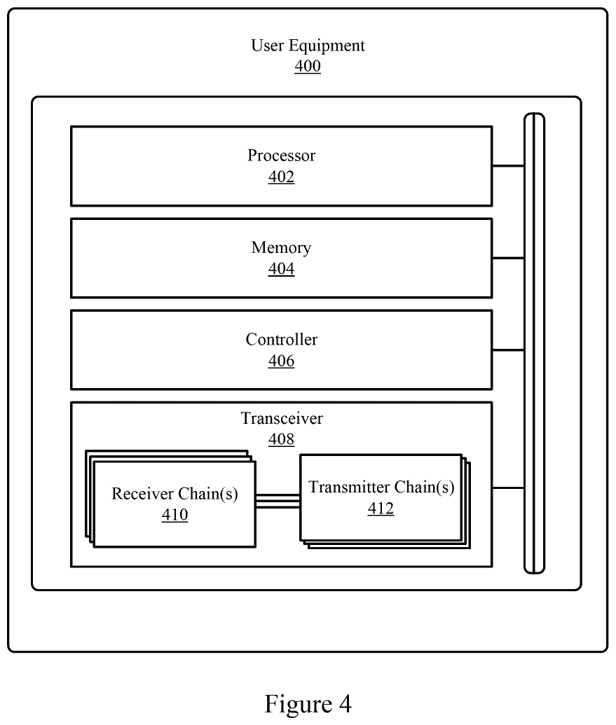

FIG. 4 illustrates an example of a UE 400 in accordance with aspects of the present disclosure. The UE 400 may include a processor 402, a memory 404, a controller 406, and a transceiver 408. The processor 402, the memory 404, the controller 406, or the transceiver 408, or various combinations thereof or various components thereof may be examples of means for performing various aspects of the present disclosure as described herein. These components may be coupled (e.g., operatively, communicatively, functionally, electronically, electrically) via one or more interfaces.

The processor 402, the memory 404, the controller 406, or the transceiver 408, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 402 may include an intelligent hardware device (e.g., a general-purpose processor, a DSP, a CPU, an ASIC, an FPGA, or any combination thereof). In some implementations, the processor 402 may be configured to operate the memory 404. In some other implementations, the memory 404 may be integrated into the processor 402. The processor 402 may be configured to execute computer-readable instructions stored in the memory 404 to cause the UE 400 to perform various functions of the present disclosure.

The memory 404 may include volatile or non-volatile memory. The memory 404 may store computer-readable, computer-executable code including instructions when executed by the processor 402 cause the UE 400 to perform various functions described herein. The code may be stored in a non-transitory computer-readable medium such the memory 404 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 402 and the memory 404 coupled with the processor 402 may be configured to cause the UE 400 to perform one or more of the functions described herein (e.g., executing, by the processor 402, instructions stored in the memory 404). For example, the processor 402 may support wireless communication at the UE 400 in accordance with examples as disclosed herein. The UE 400 may be configured to support a means for transmitting a request for an HFL service.

The controller 406 may manage input and output signals for the UE 400. The controller 406 may also manage peripherals not integrated into the UE 400. In some implementations, the controller 406 may utilize an operating system such as iOS®, ANDROID®, WINDOWS®, or other operating systems. In some implementations, the controller 406 may be implemented as part of the processor 402.

In some implementations, the UE 400 may include at least one transceiver 408. In some other implementations, the UE 400 may have more than one transceiver 408. The transceiver 408 may represent a wireless transceiver. The transceiver 408 may include one or more receiver chains 410, one or more transmitter chains 412, or a combination thereof.

A receiver chain 410 may be configured to receive signals (e.g., control information, data, packets) over a wireless medium. For example, the receiver chain 410 may include one or more antennas for receiving the signal over the air or wireless medium. The receiver chain 410 may include at least one amplifier (e.g., a low-noise amplifier (LNA)) configured to amplify the received signal. The receiver chain 410 may include at least one demodulator configured to demodulate the received signal and obtain the transmitted data by reversing the modulation technique applied during transmission of the signal. The receiver chain 410 may include at least one decoder for decoding the demodulated signal to receive the transmitted data.

A transmitter chain 412 may be configured to generate and transmit signals (e.g., control information, data, packets). The transmitter chain 412 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 412 may also include at least one power amplifier configured to amplify the modulated signal to an appropriate power level suitable for transmission over the wireless medium. The transmitter chain 412 may also include one or more antennas for transmitting the amplified signal into the air or wireless medium.

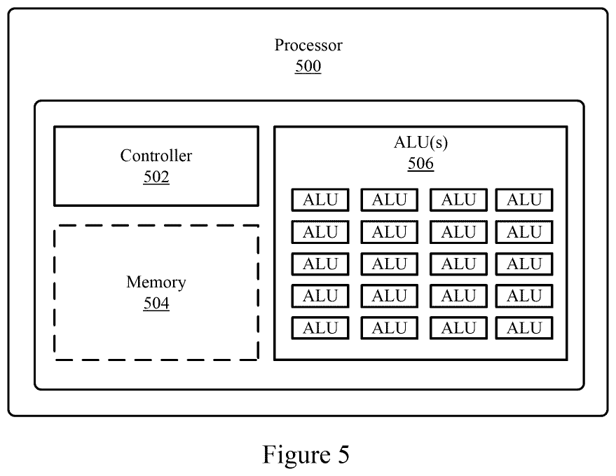

FIG. 5 illustrates an example of a processor 500 in accordance with aspects of the present disclosure. The processor 500 may be an example of a processor configured to perform various operations in accordance with examples as described herein. The processor 500 may include a controller 502 configured to perform various operations in accordance with examples as described herein. The processor 500 may optionally include at least one memory 504, which may be, for example, an L1/L2/L3 cache. Additionally, or alternatively, the processor 500 may optionally include one or more arithmetic-logic units (ALUs) 506. One or more of these components may be in electronic communication or otherwise coupled (e.g., operatively, communicatively, functionally, electronically, electrically) via one or more interfaces (e.g., buses).

The processor 500 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 500) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 502 may be configured to manage and coordinate various operations (e.g., signaling, receiving, obtaining, retrieving, transmitting, outputting, forwarding, storing, determining, identifying, accessing, writing, reading) of the processor 500 to cause the processor 500 to support various operations in accordance with examples as described herein. For example, the controller 502 may operate as a control unit of the processor 500, generating control signals that manage the operation of various components of the processor 500. These control signals include enabling or disabling functional units, selecting data paths, initiating memory access, and coordinating timing of operations.

The controller 502 may be configured to fetch (e.g., obtain, retrieve, receive) instructions from the memory 504 and determine subsequent instruction(s) to be executed to cause the processor 500 to support various operations in accordance with examples as described herein. The controller 502 may be configured to track memory address of instructions associated with the memory 504. The controller 502 may be configured to decode instructions to determine the operation to be performed and the operands involved. For example, the controller 502 may be configured to interpret the instruction and determine control signals to be output to other components of the processor 500 to cause the processor 500 to support various operations in accordance with examples as described herein. Additionally, or alternatively, the controller 502 may be configured to manage flow of data within the processor 500. The controller 502 may be configured to control transfer of data between registers, arithmetic logic units (ALUs), and other functional units of the processor 500.

The memory 504 may include one or more caches (e.g., memory local to or included in the processor 500 or other memory, such RAM, ROM, DRAM, SDRAM, SRAM, MRAM, flash memory, etc. In some implementations, the memory 504 may reside within or on a processor chipset (e.g., local to the processor 500). In some other implementations, the memory 504 may reside external to the processor chipset (e.g., remote to the processor 500).

The memory 504 may store computer-readable, computer-executable code including instructions that, when executed by the processor 500, cause the processor 500 to perform various functions described herein. The code may be stored in a non-transitory computer-readable medium such as system memory or another type of memory. The controller 502 and/or the processor 500 may be configured to execute computer-readable instructions stored in the memory 504 to cause the processor 500 to perform various functions. For example, the processor 500 and/or the controller 502 may be coupled with or to the memory 504, the processor 500, the controller 502, and the memory 504 may be configured to perform various functions described herein. In some examples, the processor 500 may include multiple processors and the memory 504 may include multiple memories. One or more of the multiple processors may be coupled with one or more of the multiple memories, which may, individually or collectively, be configured to perform various functions herein.

The one or more ALUs 506 may be configured to support various operations in accordance with examples as described herein. In some implementations, the one or more ALUs 506 may reside within or on a processor chipset (e.g., the processor 500). In some other implementations, the one or more ALUs 506 may reside external to the processor chipset (e.g., the processor 500). One or more ALUs 506 may perform one or more computations such as addition, subtraction, multiplication, and division on data. For example, one or more ALUs 506 may receive input operands and an operation code, which determines an operation to be executed. One or more ALUs 506 be configured with a variety of logical and arithmetic circuits, including adders, subtractors, shifters, and logic gates, to process and manipulate the data according to the operation. Additionally, or alternatively, the one or more ALUs 506 may support logical operations such as AND, OR, exclusive-OR (XOR), not-OR (NOR), and not-AND (NAND), enabling the one or more ALUs 506 to handle conditional operations, comparisons, and bitwise operations.

The processor 500 may support wireless communication in accordance with examples as disclosed herein. The processor 500 may be configured to or operable to support a means for transmitting a request for an HFL service.

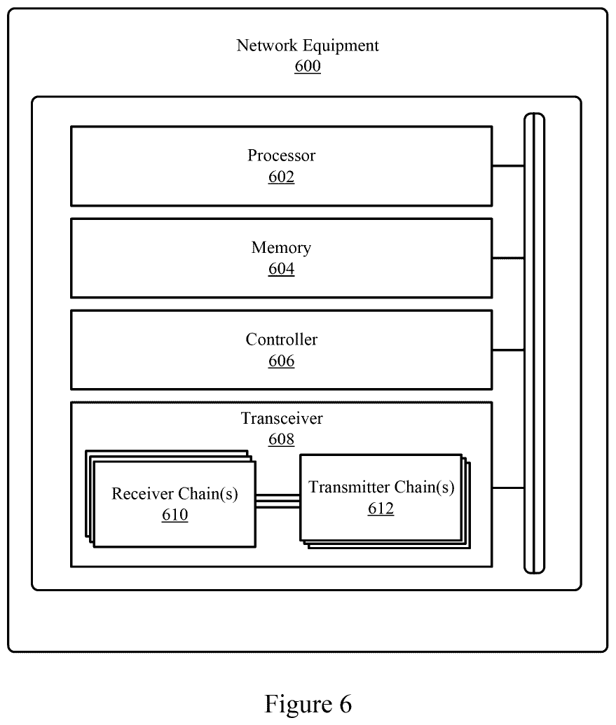

FIG. 6 illustrates an example of a NE 600 in accordance with aspects of the present disclosure. The NE 600 may include a processor 602, a memory 604, a controller 606, and a transceiver 608. The processor 602, the memory 604, the controller 606, or the transceiver 608, or various combinations thereof or various components thereof may be examples of means for performing various aspects of the present disclosure as described herein. These components may be coupled (e.g., operatively, communicatively, functionally, electronically, electrically) via one or more interfaces.

The processor 602, the memory 604, the controller 606, or the transceiver 608, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 602 may include an intelligent hardware device (e.g., a general-purpose processor, a DSP, a CPU, an ASIC, an FPGA, or any combination thereof). In some implementations, the processor 602 may be configured to operate the memory 604. In some other implementations, the memory 604 may be integrated into the processor 602. The processor 602 may be configured to execute computer-readable instructions stored in the memory 604 to cause the NE 600 to perform various functions of the present disclosure.

The memory 604 may include volatile or non-volatile memory. The memory 604 may store computer-readable, computer-executable code including instructions when executed by the processor 602 cause the NE 600 to perform various functions described herein. The code may be stored in a non-transitory computer-readable medium such the memory 604 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 602 and the memory 604 coupled with the processor 602 may be configured to cause the NE 600 to perform one or more of the functions described herein (e.g., executing, by the processor 602, instructions stored in the memory 604). For example, the processor 602 may support wireless communication at the NE 600 in accordance with examples as disclosed herein. The NE 600 may be configured to support a means for receiving a request for an HFL service.

The controller 606 may manage input and output signals for the NE 600. The controller 606 may also manage peripherals not integrated into the NE 600. In some implementations, the controller 606 may utilize an operating system such as iOS®, ANDROID®, WINDOWS®, or other operating systems. In some implementations, the controller 606 may be implemented as part of the processor 602.

In some implementations, the NE 600 may include at least one transceiver 608. In some other implementations, the NE 600 may have more than one transceiver 608. The transceiver 608 may represent a wireless transceiver. The transceiver 608 may include one or more receiver chains 610, one or more transmitter chains 612, or a combination thereof.

A receiver chain 610 may be configured to receive signals (e.g., control information, data, packets) over a wireless medium. For example, the receiver chain 610 may include one or more antennas for receiving the signal over the air or a wireless medium. The receiver chain 610 may include at least one amplifier (e.g., a low-noise amplifier (LNA)) configured to amplify the received signal. The receiver chain 610 may include at least one demodulator configured to demodulate the received signal and obtain the transmitted data by reversing the modulation technique applied during transmission of the signal. The receiver chain 610 may include at least one decoder for decoding the demodulated signal to receive the transmitted data.

A transmitter chain 612 may be configured to generate and transmit signals (e.g., control information, data, packets). The transmitter chain 612 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 612 may also include at least one power amplifier configured to amplify the modulated signal to an appropriate power level suitable for transmission over the wireless medium. The transmitter chain 612 may also include one or more antennas for transmitting the amplified signal into the air or wireless medium.

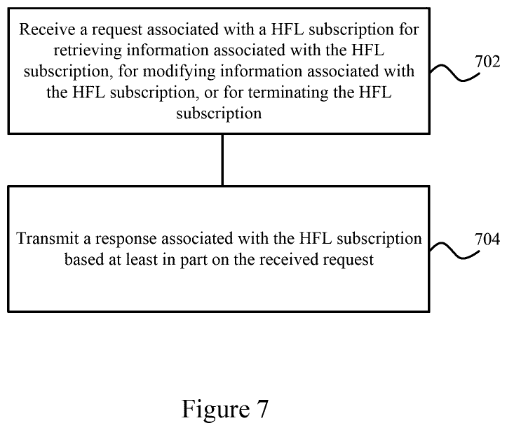

FIG. 7 illustrates a flowchart of a method in accordance with aspects of the present disclosure. The operations of the method may be implemented by a UE as described herein. In some implementations, the UE may execute a set of instructions to control the function elements of the UE to perform the described functions.

At 702, the method may include receiving, from a network entity, a request associated with a Horizontal Federated Learning (HFL) subscription for retrieving information associated with the HFL subscription, for modifying information associated with the HFL subscription, or for terminating the HFL subscription. The operations of 702 may be performed in accordance with examples as described herein. In some implementations, aspects of the operations of 702 may be performed by a UE as described with reference to FIG. 4.

At 704, the method may include transmitting, to the network entity, a response associated with the HFL subscription based at least in part on the received request. The operations of 704 may be performed in accordance with examples as described herein. In some implementations, aspects of the operations of 704 may be performed by a UE as described with reference to FIG. 4.

It should be noted that the method described herein describes a possible implementation, and that the operations and the steps may be rearranged or otherwise modified and that other implementations are possible.

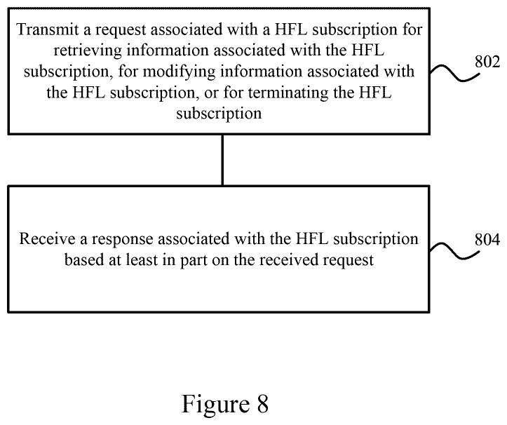

FIG. 8 illustrates a flowchart of a method in accordance with aspects of the present disclosure. The operations of the method may be implemented by a NE as described herein. In some implementations, the NE may execute a set of instructions to control the function elements of the NE to perform the described functions.

At 802, the method may include transmitting a request associated with a Horizontal Federated Learning (HFL) subscription for retrieving information associated with the HFL subscription, for modifying information associated with the HFL subscription, or for terminating the HFL subscription. The operations of 802 may be performed in accordance with examples as described herein. In some implementations, aspects of the operations of 802 may be performed by a NE as described with reference to FIG. 6.

At 804, the method may include transmitting a response associated with the HFL subscription based at least in part on the received request. The operations of 804 may be performed in accordance with examples as described herein. In some implementations, aspects of the operations of 804 may be performed by a NE as described with reference to FIG. 6.

It should be noted that the method described herein describes a possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A UE for wireless communication, comprising:
one or more memories; and
one or more processors coupled with the one or more memories and individually or collectively configured to cause the UE to:
receive, from a network entity, a request associated with a Horizontal Federated Learning (HFL) subscription for retrieving information associated with the HFL subscription, for modifying information associated with the HFL subscription, or for terminating the HFL subscription; and
transmit, to the network entity, a response associated with the HFL subscription based at least in part on the received request,
wherein the UE is an Artificial Intelligence Machine Learning Enablement (AIMLE) client, and wherein the network entity is an AIMLE server.

2. The UE of claim 1, wherein, to transmit the response associated with the HFL subscription, the one or more processors are further individually or collectively configured to cause the UE to output training subscription data based at least in part on the received request being for retrieving information associated with the HFL subscription.

3. The UE of claim 2, wherein the request is a Hypertext Transfer Protocol (HTTP) GET request.

4. The UE of claim 2, wherein the response comprises the training subscription data requested by the network entity.

5. The UE of claim 1, wherein the one or more processors are further individually or collectively configured to cause the UE to modify one or more parameters associated with the HFL subscription based at least in part on the received request being for modifying information associated with the HFL subscription.

6. The UE of claim 5, wherein the request is an HTTP PATCH request, and wherein the HTTP PATCH request indicates at least one parameter to be modified and a modified value for the at least one parameter.

7. The UE of claim 5, wherein the one or more processors are further individually or collectively configured to cause the UE to replace the HFL training service, to which the network is subscribed with the UE, and the request is an HTTP PUT request.

8. The UE of claim 1, wherein the one or more processors are further individually or collectively configured to cause the UE to terminate an HFL subscription of the UE based at least in part on the received request being for terminating the HFL subscription.

9. The UE of claim 8, wherein the request is an HTTP DELETE request.

10. The UE of claim 1, wherein the response includes one of:
an indication that the request was successfully executed by the UE;
a redirection to a different UE; and
an indication that the UE failed to successfully execute the request.

11. A method performed by a user equipment (UE), the method comprising:
receiving, from a network entity, a request associated with a Horizontal Federated Learning (HFL) subscription for retrieving information associated with the HFL subscription, for modifying information associated with the HFL subscription, or for terminating the HFL subscription; and
transmitting, to the network entity, a response associated with the HFL subscription based at least in part on the received request,
wherein the UE is an Artificial Intelligence Machine Learning Enablement (AIMLE) client, and wherein the network entity is an AIMLE server.

12. The method of claim 11, wherein transmitting the response associated with the HFL subscription includes outputting training subscription data based at least in part on the received request being for retrieving information associated with the HFL subscription.

13. The method of claim 12, wherein the request is a Hypertext Transfer Protocol (HTTP) GET request.

14. The method of claim 12, wherein the response comprises the training subscription data requested by the network entity.

15. The method of claim 11, further comprising:
modifying one or more parameters associated with the HFL subscription based at least in part on the received request being for modifying information associated with the HFL subscription.

16. The method of claim 15, wherein the request is an HTTP PATCH request, and wherein the HTTP PATCH request indicates at least one parameter to be modified and a modified value for the at least one parameter.

17. The method of claim 15, further comprising:
replacing the HFL training service, to which the network is subscribed with the UE, wherein the request is an HTTP PUT request.

18. The method of claim 11, further comprising:
terminating an HFL subscription of the UE based at least in part on the received request being terminating the HFL subscription.

19. The method of claim 18, wherein the request is an HTTP DELETE request.

20. A network entity for wireless communication, comprising:
one or more memories; and
one or more processors coupled with the one or more memories and individually or collectively configured to cause the network entity to:
transmit, to a user equipment (UE), a request associated with a Horizontal Federated Learning (HFL) subscription for retrieving information associated with the HFL subscription, for modifying information associated with the HFL subscription, or for terminating the HFL subscription; and
receive, from the UE, a response associated with the HFL subscription based at least in part on the received request,
wherein the UE is an Artificial Intelligence Machine Learning Enablement (AIMLE) client, and wherein the network entity is an AIMLE server.
